(19) United States
(12) Patent Application Publication
(10) Pub. No.: US 2018/0108027 A1
(43) Pub. Date: Apr. 19, 2018

(54) FRAMEWORKS AND METHODOLOGIES CONFIGURED TO ENABLE GATHERING AND SELECTIVE SHARING OF PRE-SALE INTELLIGENCE DATA, INCLUDING APPLICATION IN COMPUTER INTERFACES FOR SALE OF LIVE ANIMALS

(71) Applicant: ThoroughWorks Pty Ltd, Reedy Creek (AU)

(72) Inventors: Jack Michael Ernest Halford, Reedy Creek (AU); Christopher James King, Reedy Creek (AU)

(21) Appl. No.: 15/297,313

(22) Filed: Oct. 19, 2016

(51) Int. Cl. G06Q 30/02; G06F 17/30; G06Q 30/08

(52) U.S. Cl. CPC G06Q 30/0202; G06Q 30/08; G06F 17/30424

(57) ABSTRACT

Described herein are frameworks and methodologies configured to enable pre-auction data collection and selective sharing of intelligence data, which in some embodiments finds application in the context of sale of live animals. Embodiments described herein by reference to a computer platform that provides functionality to enable management of item profiles (including item profiles for animals) in the context of collecting and providing pre-sale intelligence for vendors.

### FIELD OF THE INVENTION

The present invention relates frameworks and methodologies configured to enable gathering and selective sharing of pre-sale intelligence data, including application in computer interfaces for sale of live animals. Embodiments described herein by reference to a computer platform that provides functionality to enable management of item profiles (including item profiles for animals) in the context of collecting and providing pre-sale intelligence for vendors. However, it will be appreciated that the technology has broader application.

### BACKGROUND

Any discussion of the background art throughout the specification should in no way be considered as an admission that such art is widely known or forms part of common general knowledge in the field.

Online sales and auction platforms have increased in popularity and functionality over the past decade. However, there are numerous practical situations where computer-implemented auctioning is out of favour. For example, the sale of animals (for example livestock, horses, and so on) remains primarily in the realm of traditional auctioning. This leads to technical challenges in terms of gathering and making use of pre-sale intelligence data.

### SUMMARY OF THE INVENTION

It is an object of the present invention to overcome or ameliorate at least one of the disadvantages of the prior art, or to provide a useful alternative.

One embodiment provides a computer system configured to enable gathering and sharing of pre-sale information, the system including:

a profile management portal, wherein the profile management portal is accessible via a plurality of registered vendor users via receive networked client terminals, wherein the profile management portal is configured to enable a given vendor user to create and manage a plurality of item profiles, wherein each item profile is configured to be associated with data relating to a respective item and the creating vendor user, the data including a unique item ID;

a profile viewing portal, wherein the profile management portal is accessible via a plurality of users via receive networked client terminals, wherein the profile viewing portal enables rendering at a given client terminal of a user interface that displays data representative of one or more item profiles;

a sales event management portal, wherein the sales event management portal is accessible via a plurality of registered vendor users via receive networked client terminals, wherein the sales event management portal is configured to enable a given vendor user to select one or more of the item profiles associated with that vendor user, and additionally associate those selected item profiles with a defined sales event;

a pre-sale intelligence input portal, wherein the pre-sale intelligence input portal is accessible via a one or more networked client terminals, the pre-sale intelligence input portal being configured to enable inputting, in accordance with a predefined data framework, of data representative of physical interactions involving respective items for which unique item IDs are defined;

a data management module, wherein the data management module is configured to process and store data received via the pre-sale intelligence input portal, thereby to make data available via one or more data query and access modules;

a vendor intelligence portal, wherein the vendor intelligence portal is accessible via a plurality of registered vendor users via receive networked client terminals, wherein the vendor intelligence portal is configured to:

(i) identify a particular vendor user accessing the vendor intelligence portal;

(ii) identify a particular sales event;

(iii) identify one or more items associated with the particular vendor user and the particular sales event;

(iv) operate a data query and access module thereby to extract from data processed and stored by the data management module, data that enables rendering at a client terminal operated by the particular vendor user a representation of a report that shows a comparison between the one or more identified items and a plurality of other items associated with the particular sales event based on at least one metric associated with a form of physical interaction.

One embodiment provides a computer implemented method configured to enable gathering and sharing of pre-sale information, the system including:

operating a profile management portal, wherein the profile management portal is accessible via a plurality of users via receive networked client terminals, wherein the profile management portal is configured to enable a given vendor user to create and manage a plurality of item profiles, wherein each item profile is configured to be associated with data relating to a respective item and the creating vendor user, the data including a unique item ID;

operating a profile viewing portal, wherein the profile management portal is accessible via a plurality of registered buyer users via receive networked client terminals, wherein the profile viewing portal enables rendering at a given client terminal of a user interface that displays data representative of one or more item profiles;

operating a sales event management portal, wherein the sales event management portal is accessible via a plurality of registered vendor users via receive networked client terminals, wherein the sales event management portal is configured to enable a given vendor user to select one or more of the item profiles associated with that vendor user, and additionally associate those selected item profiles with a defined sales event;

operating a pre-sale intelligence input portal, wherein the pre-sale intelligence input portal is accessible via a one or more networked client terminals, the pre-sale intelligence input portal being configured to enable inputting, in accordance with a predefined data framework, of data representative of physical interactions involving respective items for which unique item IDs are defined;

operating a data management module, wherein the data management module is configured to process and store data received via the pre-sale intelligence input portal, thereby to make data available via one or more data query and access modules;

operating a vendor intelligence portal, wherein the vendor intelligence portal is accessible via a plurality of registered vendor users via receive networked client terminals, wherein the vendor intelligence portal is configured to:

(i) identify a particular vendor user accessing the vendor intelligence portal;

(ii) identify a particular sales event;

(iii) identify one or more items associated with the particular vendor user and the particular sales event;

(iv) operate a data query and access module thereby to extract from data processed and stored by the data management module, data that enables rendering at a client terminal operated by the particular vendor user a representation of a report that shows a comparison between the one or more identified items and a plurality of other items associated with the particular sales event based on at least one metric associated with a form of physical interaction.

One embodiment provides a computer system configured to enable gathering and sharing of pre-sale information, the system including:

a pre-sale intelligence input portal, wherein the pre-sale intelligence input portal is accessible via a one or more networked client terminals, the pre-sale intelligence input portal being configured to enable inputting, in accordance with a predefined data framework, of data representative of physical interactions involving respective items for which unique item IDs are defined;

a data management module, wherein the data management module is configured to process and store data received via the pre-sale intelligence input portal, thereby to make data available via one or more data query and access modules;

a vendor intelligence portal, wherein the vendor intelligence portal is accessible via a plurality of registered vendor users via receive networked client terminals, wherein the vendor intelligence portal is configured to:

(i) identify a particular vendor user accessing the vendor intelligence portal;

(ii) identify a particular sales event;

(iii) identify one or more items associated with the particular vendor user and the particular sales event;

(iv) operate a data query and access module thereby to extract from data processed and stored by the data management module, data that enables rendering at a client terminal operated by the particular vendor user a representation of a report that shows a comparison between the one or more identified items and a plurality of other items associated with the particular sales event based on at least one metric associated with a form of physical interaction.

One embodiment provides a computer program product for performing a method as described herein.

One embodiment provides a non-transitory carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1 schematically illustrates a framework according to one embodiment.

FIG. 2 illustrates a method according to one embodiment.

FIG. 3 illustrates a client/server framework leveraged by various embodiments.

FIGS. 4A and 4B illustrate screenshots according to an example embodiment.

### DETAILED DESCRIPTION

Described herein are frameworks and methodologies configured to enable pre-auction data collection and selective sharing of intelligence data, which in some embodiments finds application in the context of sale of live animals. Embodiments described herein by reference to a computer platform that provides functionality to enable management of item profiles (including item profiles for animals) in the context of collecting and providing pre-sale intelligence for vendors.

### Overview

Embodiments are described below by reference to technological platforms that enable the gathering and automated processing/presentation of pre-sales intelligence data. It should be appreciated, however, that the technology is not necessarily limited to “pre-sales intelligence” data, and is equally applicable to other forms of data in alternate implementation environments. That is, the underlying technology platforms are not “sales-specific” from a business perspective, may find broader application as the technology is applied elsewhere.

In overview, embodiments of the technology provide computer technology (including methods, frameworks, systems, and so on) that enable the rendering of user interfaces via networked client terminals, thereby to gather, process and share elements of data in a particular manner. At a high level, the embodiments described below relate to (i) creation and maintenance of profiles for “items”; (ii) association of items having profiles with sales events; (iii) inputting of data collected in relation to physical observations made in the lead up to a sales event; (iv) processing of that data; and (v) delivering report data via a user interface such that vendor user are provided with pre-sales intelligence data (for example in the lead up to an auction), this data providing relative guidance by reference to other vendor's items (which are not specifically identified).

Embodiments are described by reference to a specific example in the context of thoroughbred horses, which are sold via physical auction events. This example is not intended to be limiting, and is provided as context to a particular implementation environment for the underlying technology.

### Example Framework

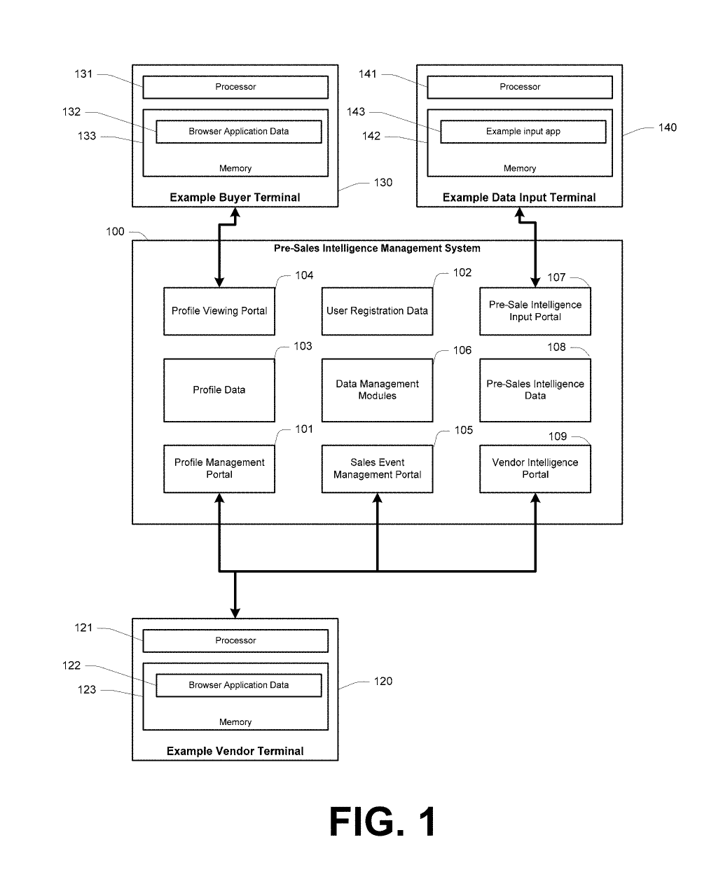

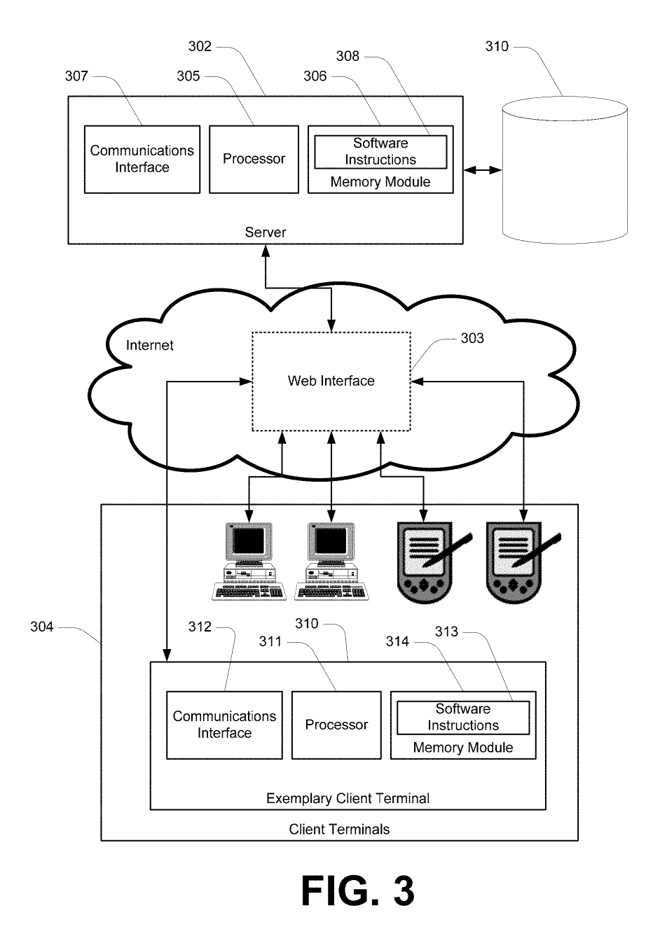

FIG. 1 illustrates an example computer system framework configured to enable gathering and sharing of pre-sale information. The framework is described by reference to a central system, which communicates with a plurality of client terminals via a network (for example via a client-server framework based on that shown in FIG. 3). In general terms, the communication between the central system and the terminals may be via the Internet (for example via a web browser arrangement) and/or via local networks (for example at a remote location where there is a local network by no shared Internet connection. The framework is also described by reference to a plurality of “modules”. These modules represent collections of computer executable code that are executed via one or more processors thereby to deliver a functionality. The modules are in this manner functionally defined, and this separation is independent of matters of practical implementation whereby modules are split between or combined into individual software products/platforms.

FIG. 1 centres upon a pre-sales intelligence management server 100. This server is in some embodiments provided by a plurality of separate networked systems and/or devices. That is, whilst the diagram shows a single discrete component, in practical embodiments there may be multiple computing terminals collectively providing functionality of server 100.

System 100 provides a profile management portal 101. Profile management portal 101 is accessible via a plurality of registered vendor users via receive networked client terminals. A “registered vendor user” is a user identified based on inputted credentials which are authenticated against user registration data 102. In that regard, a person interacts with a registration module/user interface provided by system 100 thereby to create a vendor account, which is identifiable via a unique vendor account ID. A vendor is not at all times engaged in sales; a vendor is in essence an owner or owner representative, who may at some sate adopt a practical role as vendor of an item for which re-sales intelligence is relevant.

An example vendor client terminal 120 is illustrated. Example vendor terminal 120 includes a processor 121 which is configured to execute computer executable code maintained in a memory module 123. This code presently includes a web browser application 122, which is configured to download and render web page data from a web server provided via (or in association with) system 100, thereby to deliver a user interface for profile management portal 101 (in some embodiments proprietary apps are used as an alternative to a web browser). In this manner, the profile management portal is configured to enable a given vendor user to create and manage a plurality of “item profiles”.

As described herein, an “item profile” is a collection of data, defined in accordance with a predefined data protocol, which describes an “item”. In practical terms, this is an item that may at some stage be sold via a physical sales event, such as an auction. For the present purposes, the example of a thoroughbred horse is used. Each item profile is configured to be associated with data relating to a respective item and the creating vendor user (for instance via the vendor account ID), the data including a unique item ID. This is stored in a repository of profile data 103.

In a preferred embodiments wherein the items represent animals, each item profile is configured to be associated with data relating to a respective item including one or more of:
A collection of historical measurement data. This allows an owner to periodically update a item profile with updated measurements, and in doing so enable the generation of data presentations, reports, and so on which provide a graphical representation of an animal's growth over time.
Medical records, for example vet visits, treatments, and so on.
Performance data, including either or both of competitive and training data.
Genealogy data (for example information relating to a sire).

The present profile interface enables a vendor user to maintain (e.g. periodically update) profiles for their animas over time, thereby to maintain a sharable central record. For example, the sharing may include making the profile data (or a subset thereof) available to other persons (for example prospective buyers). In that regard, system 100 provides a profile viewing portal 104.

Profile viewing portal 104 enables a user of a client terminal to render a user interface that displays data representative of one or more item profiles. The nature of the use interface, profiles available, and/or extent of data available preferably depends on permissions associated with the particular user. For example:
Vendor users are provided with full access to view profiles for their own items.
Vendor users may set varying levels of permissions for all or a subset of their items for viewing by third parties, including buyer users (i.e. users registered as prospective buyers) and other vendor users (who may also in practice be prospective buyers).
Permissions may be set based on a user-specific basis (for example based on user ID; a specific user is granted access to view item profiles for all or a subset of a given vendor user's items), or based on attributes associated with particular users (for example registration for a given sales event; users registered to attend a sales event are granted access to all or a subset of items also associated with that sales event).

An example buyer terminal 130 is illustrated. Example buyer terminal 130 includes a processor 131 which is configured to execute computer executable code maintained in a memory module 133. This code presently includes a web browser application 132, which is configured to download and render web page data from a web server provided via (or in association with) system 100, thereby to deliver a user interface for profile management portal 101 (in some embodiments proprietary apps are used as an alternative to a web browser). In this manner, the profile viewing portal is configured to enable a buyer vendor user view a user interface configured to deliver data representative of a collection of item profiles for which the buyer user has adequate permissions (for example based on a permission determination module which is configured to process a set of permission determination rules thereby to determine to which item profiles a given user is to be granted access).

In some embodiments, item profiles are transferrable between vendor users. This allows for a common item profile to be created by a first user, maintained by that first user for a period of time, transferred to a second user, and then maintained by that second user for a subsequent period of time. This allows a common profile to be retained in spite of a transfer of ownership between two different user accounts. It is appreciated that the second user, whilst described herein as a “vendor user”, might never practically sell the item or make use of functionalities of system 100 relevant to sales.

System 100 provides a sales event management portal 105, which is accessible via a plurality of registered vendor users via receive networked client terminals (such as example vendor terminal 120). The sales event management portal is configured to enable a given vendor user to select one or more of the item profiles associated with that vendor user, and additionally associate those selected item profiles with a defined sales event. For example, using the specific example of thoroughbred horses, a vendor user identifies which if his/her horses are going to be put on sale at a particular upcoming auction at which functionalities of system 100 will be in play (as discussed below). As noted above, the association of an item with a sales event modifies profile data, which optionally has an effect in terms of affecting access permissions for third parties to view an item profile.

System 100 also provides a pre-sale intelligence input portal 107. The pre-sale intelligence input portal is also accessible via a one or more networked client terminals. At a practical level, a preferred embodiment makes use of mobile devices such as tablets to access portal 106, these being operated by persons engaged (by a party associated with system 100) to observe physical interactions at a sales event, thereby to gather intelligence for vendors. Portal 107 is configured to enable inputting, in accordance with a predefined data framework, of data representative of physical interactions involving respective items for which unique item IDs are defined. For example, this data may include:
Physical item viewings.
Details of viewers (for example names, or unique non-personalising identifiers).
Viewing durations.
Viewing interactions (for example requests for particular information, etc).

This data may be collected by input terminals such as example input terminal 140, which a processor 141 which is configured to execute computer executable code maintained in a memory module 143. This code presently includes an input app, which provides a user interface specifically configured to enable convenient inputting of data representative of physical interactions. In some embodiments the data is alternately collected via non-technological means (for example paper forms) and inputted into an interface provided in conjunction with portal 107 as a subsequent step. The data is processed (optionally including transformation, normalisation, etc.) and stored in pre-sales intelligence data 108. One or more data management modules 106 are configured to process and store data received via the pre-sale intelligence input portal, thereby to make data available via one or more data query and access modules.

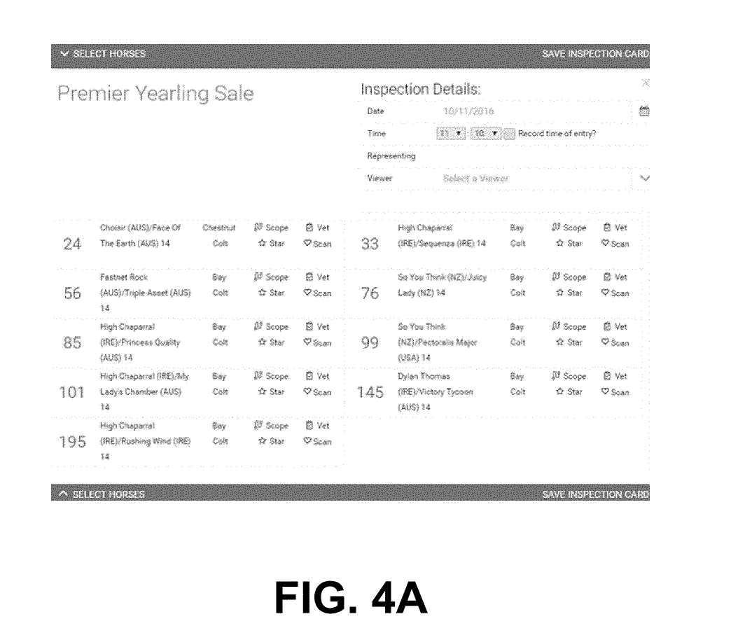

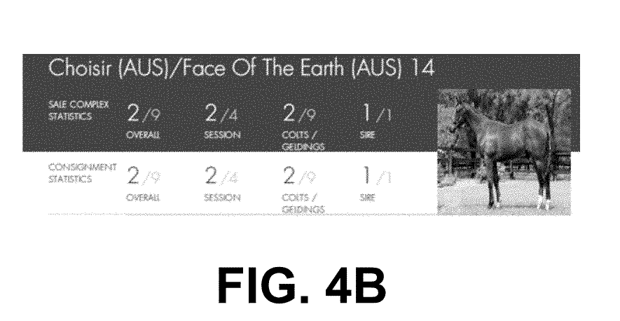

FIG. 4A illustrates an example rendering of a user interface provided by a pre-sale intelligence input portal according to one embodiment. This provides an electronically generated inspection card, displaying a plurality of horses having profiles associated with a “Premier Yearling Sale”. The interface includes inputs for a date, a time (if known), a viewer, and a party whom that viewer is representing (for example where a vet or assistant is viewing horses on behalf of a potential buyer). The provision of both “viewer” and “representing” inputs allows normalisation across interested parties in spite of multiple individual viewers, whilst retaining richness of data from recording individual viewers.

The example user interface allows a user to click a region associated with a given horse (for example “Fastnet Rock”). There are also selectable UI objects to indicate particular forms of physical interaction, in this case being a “scope”, “vet” and “scan” option, relating to common horse checks that are performed at viewings. Additionally, a “star” option is selectable, thereby to indicate, based on subjective assessment of the observer, that a particular viewer is especially interested (i.e. likely to make a decision to purchase). The “star” option is used for the purpose of weighting/ordering of results in a subsequent report in some embodiments, such that likely purchasers are distinguished from general inspecting persons.

In some embodiments an API is used to enable uploading of additional pre-sale intelligence data from external systems (not shown). For example, in some embodiments a software module operates on a computing terminal associated with a provider of horse X-Ray data, and causes upload of data indicative of requests for X-Rays by persons in respect of horses for which profiles are defined.

In the illustrated example, data query and access modules are provided via a vendor intelligence portal 109. The vendor intelligence portal is accessible via a plurality of registered vendor users via receive networked client terminals, such as example vendor terminal 120.

Vendor intelligence portal 109 is configured to:
(i) Identify a particular vendor user accessing the vendor intelligence portal (for example based on inputted credentials).
(ii) Identify a particular sales event (for example based on user input/selection).
(iii) Identify one or more items associated with the particular vendor user and the particular sales event (for example based on associations made via portal 105, which are stored in profile data 103).
(iv) Operate a data query and access module thereby to extract from data processed and stored by the data management module (data 108), data that enables rendering at a client terminal operated by the particular vendor user a representation of a report that shows a comparison between the one or more identified items and a plurality of other items associated with the particular sales event based on at least one metric associated with a form of physical interaction. In a preferred embodiment, the report provides a relative ranking of a given one or the items associated with the particular vendor user with other items associated with the particular sales event against a predefined metric.

The report data provided via portal 109 is configured to enable a vendor user to view data representative of the performance of one or more of their items at a sales event based on pre-sales intelligence data gathered based on the data representative of physical interactions. For example, the vendor is able to view one or more of the following:
Physical item viewings.
Physical item viewings broken down by unique viewers.
Physical item viewings broken down by viewing duration.
Physical item viewings broken down by unique viewers and viewing duration.
Requests for additional information.
Breakdowns based on subsets of items (for example a vendor's own items, items in a common category, items with common attributes, etc.).

The report in some embodiments provides a comparison between one or more of the vendor user's items with other items associated with the sales event. Those other items are non-specifically identified, such that the particular vendor user is not enabled to determine an item ID or item profile for those items. In this manner, the vendor user is in some embodiments presented with relative ranking data, thereby to provide an indication of how popular (based on physical interactions) his/her items are by comparison to other items at the sales event (for example based on raw interaction metrics, percentile-based ratings based on interaction metrics, and so on).

An example portion of a rendered report is provided in FIG. 4B. This report shows a relative rating for a horse (called “Choisir/Face Of The Earth) against a metric of viewing numbers. This shows that for a given sales event, that horse has is ranked 2^{nd} of 9 in terms of viewing numbers, 2^{nd} of 4 for a particular sales session 2^{nd} of 9 for gender, and 1^{st} out of 1 for horses with that sire. The report preferably additionally provides further details based on data collected by the interface of FIG. 4A, for example in terms of persons who viewed, performed medial inspections, and so on.

In some embodiments the report is configured to automatically calculate provide a predicted estimated sales value. This is based upon a combination of the following factors: (i) number of viewings; (ii) historical purchase prices paid by one or more top viewers (based on sales data from previous sales events); and (iii) historical purchase prices for horses with the same sire. For example, one approach is to calculate a weighted average of historical purchase prices of the top 3 viewers, which is adjusted based on sales of a common sire (for example an upward or downward adjustment based on sire-based relativities against average sales).

### Example Method

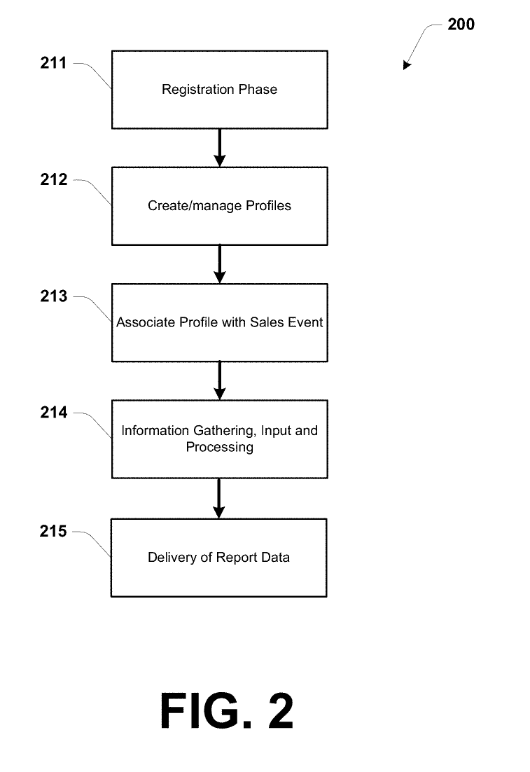

FIG. 2 illustrates a method 200 according to one embodiment, being an overall process flow that is optionally delivered via the framework of FIG. 1.

Block 211 represents a registration phase, whereby a vendor user registers to create an account with system 100. Then, at block 212, the vendor user creates and manages profiles for his/her items over time. This includes, at one or more junctures, associating one or more profiles with an upcoming sales event (see block 213). That association configures an input interface to receive physical observation interaction data at a sales event by persons engaged to monitor physical interactions at the sales event, with block 214 representing such information gathering, input, and processing. Report data is then able to be delivered at block 215, thereby to enable vendor users to view pre-sales intelligence data.

In general terms, pre-sales intelligence data of the sort displayed allows a vendor user to make predictions as to likely outcomes of a sales event (such as an auction). For example, it is possible to assess the popularity (and/or relative popularity) of particular items in advance, and potentially alter strategies and/or expectations accordingly.

### Exemplary Client-Server Framework

In some embodiments, methods and functionalities considered herein are implemented by way of a server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

### Interpretation

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer system configured to enable gathering and sharing of pre-sale information, the system including:
a profile management portal, wherein the profile management portal is accessible via a plurality of registered vendor users via receive networked client terminals, wherein the profile management portal is configured to enable a given vendor user to create and manage a plurality of item profiles, wherein each item profile is configured to be associated with data relating to a respective item and the creating vendor user, the data including a unique item ID;
a profile viewing portal, wherein the profile management portal is accessible via a plurality of users via receive networked client terminals, wherein the profile viewing portal enables rendering at a given client terminal of a user interface that displays data representative of one or more item profiles;
a sales event management portal, wherein the sales event management portal is accessible via a plurality of registered vendor users via receive networked client terminals, wherein the sales event management portal is configured to enable a given vendor user to select one or more of the item profiles associated with that vendor user, and additionally associate those selected item profiles with a defined sales event;
a pre-sale intelligence input portal, wherein the pre-sale intelligence input portal is accessible via a one or more networked client terminals, the pre-sale intelligence input portal being configured to enable inputting, in accordance with a predefined data framework, of data representative of physical interactions involving respective items for which unique item IDs are defined;
a data management module, wherein the data management module is configured to process and store data received via the pre-sale intelligence input portal, thereby to make data available via one or more data query and access modules;
a vendor intelligence portal, wherein the vendor intelligence portal is accessible via a plurality of registered vendor users via receive networked client terminals, wherein the vendor intelligence portal is configured to:
(i) identify a particular vendor user accessing the vendor intelligence portal;
(ii) identify a particular sales event;
(iii) identify one or more items associated with the particular vendor user and the particular sales event;
(iv) operate a data query and access module thereby to extract from data processed and stored by the data management module, data that enables rendering at a client terminal operated by the particular vendor user a representation of a report that shows a comparison between the one or more identified items and a plurality of other items associated with the particular sales event based on at least one metric associated with a form of physical interaction.

2. A system according to claim 1 wherein rendering at a client terminal operated by the particular vendor user a representation of a report that shows a comparison between the one or more identified items and a plurality of other items associated with the particular sales event based on at least one metric associated with a form of physical interaction includes: displaying relative ranking of a given one or the items associated with the particular vendor user with other items associated with the particular sales event against a predefined metric.

3. A system according to claim 1 wherein the other items associated with the particular sales event are non-specifically identified, such that the particular vendor user is not enabled to determine a item ID or item profile for those items.

4. A system according to claim 1 wherein the at least one metric associated with a form of physical interaction includes physical item viewings.

5. A system according to claim 1 wherein the at least one metric associated with a form of physical interaction includes physical item viewings broken down by unique viewers.

6. A system according to claim 1 wherein the at least one metric associated with a form of physical interaction includes physical item viewings broken down by viewing duration.

7. A system according to claim 1 wherein the at least one metric associated with a form of physical interaction includes physical item viewings broken down by unique viewers and viewing duration.

8. A system according to claim 1 wherein the at least one metric associated with a form of physical interaction includes requests for additional information.

9. A system according to claim 1 wherein the items are animals, and wherein each item profile is configured to be associated with data relating to a respective item including one or more of: a collection of historical measurement data; medical records; and performance data.

10. A system according to claim 1 including generating a predicted sales value based on analysis of past purchases by persons associated with interactions identified by pre-sales intelligence input.

11. A computer implemented method configured to enable gathering and sharing of pre-sale information, the system including:
operating a profile management portal, wherein the profile management portal is accessible via a plurality of users via receive networked client terminals, wherein the profile management portal is configured to enable a given vendor user to create and manage a plurality of item profiles, wherein each item profile is configured to be associated with data relating to a respective item and the creating vendor user, the data including a unique item ID;
operating a profile viewing portal, wherein the profile management portal is accessible via a plurality of registered buyer users via receive networked client terminals, wherein the profile viewing portal enables rendering at a given client terminal of a user interface that displays data representative of one or more item profiles;
operating a sales event management portal, wherein the sales event management portal is accessible via a plurality of registered vendor users via receive networked client terminals, wherein the sales event management portal is configured to enable a given vendor user to select one or more of the item profiles associated with that vendor user, and additionally associate those selected item profiles with a defined sales event;
operating a pre-sale intelligence input portal, wherein the pre-sale intelligence input portal is accessible via a one or more networked client terminals, the pre-sale intelligence input portal being configured to enable inputting, in accordance with a predefined data framework, of data representative of physical interactions involving respective items for which unique item IDs are defined;
operating a data management module, wherein the data management module is configured to process and store data received via the pre-sale intelligence input portal, thereby to make data available via one or more data query and access modules;
operating a vendor intelligence portal, wherein the vendor intelligence portal is accessible via a plurality of registered vendor users via receive networked client terminals, wherein the vendor intelligence portal is configured to:
(i) identify a particular vendor user accessing the vendor intelligence portal;
(ii) identify a particular sales event;
(iii) identify one or more items associated with the particular vendor user and the particular sales event;
(iv) operate a data query and access module thereby to extract from data processed and stored by the data management module, data that enables rendering at a client terminal operated by the particular vendor user a representation of a report that shows a comparison between the one or more identified items and a plurality of other items associated with the particular sales event based on at least one metric associated with a form of physical interaction.

12. A method according to claim 11 wherein rendering at a client terminal operated by the particular vendor user a representation of a report that shows a comparison between the one or more identified items and a plurality of other items associated with the particular sales event based on at least one metric associated with a form of physical interaction includes: displaying relative ranking of a given one or the items associated with the particular vendor user with other items associated with the particular sales event against a predefined metric.

13. A method according to claim 11 wherein the other items associated with the particular sales event are non-specifically identified, such that the particular vendor user is not enabled to determine a item ID or item profile for those items.

14. A method according to claim 11 wherein the at least one metric associated with a form of physical interaction includes physical item viewings.

15. A method according to claim 11 wherein the at least one metric associated with a form of physical interaction includes physical item viewings broken down by unique viewers.

16. A method according to claim 11 wherein the at least one metric associated with a form of physical interaction includes physical item viewings broken down by viewing duration.

17. A method according to claim 11 wherein the at least one metric associated with a form of physical interaction includes physical item viewings broken down by unique viewers and viewing duration.

18. A method according to claim 11 wherein the at least one metric associated with a form of physical interaction includes requests for additional information.

19. A system according to claim 1 including generating a predicted sales value based on analysis of past purchases by persons associated with interactions identified by pre-sales intelligence input.

20. A computer system configured to enable gathering and sharing of pre-sale information, the system including:
a pre-sale intelligence input portal, wherein the pre-sale intelligence input portal is accessible via a one or more networked client terminals, the pre-sale intelligence input portal being configured to enable inputting, in accordance with a predefined data framework, of data representative of physical interactions involving respective items for which unique item IDs are defined;
a data management module, wherein the data management module is configured to process and store data received via the pre-sale intelligence input portal, thereby to make data available via one or more data query and access modules;
a vendor intelligence portal, wherein the vendor intelligence portal is accessible via a plurality of registered vendor users via receive networked client terminals, wherein the vendor intelligence portal is configured to:
(i) identify a particular vendor user accessing the vendor intelligence portal;
(ii) identify a particular sales event;
(iii) identify one or more items associated with the particular vendor user and the particular sales event;
(iv) operate a data query and access module thereby to extract from data processed and stored by the data management module, data that enables rendering at a client terminal operated by the particular vendor user a representation of a report that shows a comparison between the one or more identified items and a plurality of other items associated with the particular sales event based on at least one metric associated with a form of physical interaction.
